(19) United States
(12) Patent Application Publication
(10) Pub. No.: US 2026/0153328 A1
(43) Pub. Date: Jun. 4, 2026

(54) Surface Roughness Measurement Method and Surface Roughness Measurement System

(71) Applicant: Advanced ACEBIOTEK CO., LTD., Hsinchu County (TW)

(72) Inventors: Ting Cheng, Taipei City (TW); Hui-Shun Kuan, Taipei City (TW); Yung-Chou Hsu, New Taipei City (TW); Chan-Shan Yang, Taipei City (TW); Yu-Sheng Chen, Taichung City (TW); Jyh-Chern Chen, New Taipei City (TW); Shen-Fu Hsu, Taitung County (TW)

(73) Assignee: Advanced ACEBIOTEK CO., LTD., Hsinchu County (TW)

(21) Appl. No.: 19/308,339

(22) Filed: Aug. 25, 2025

(30) Foreign Application Priority Data
Dec. 2, 2024 (TW) 113146575

(51) Int. Cl. G01B 11/30

(52) U.S. Cl. CPC G01B 11/303

(57) ABSTRACT

A surface roughness measurement method includes generating a terahertz emission electromagnetic wave incident on a test object; detecting a plurality of terahertz reception electromagnetic waves reflected, transmitted, or scattered after the terahertz emission electromagnetic wave is incident on the test object; measuring a plurality of characteristic signals based on the terahertz emission electromagnetic wave and the plurality of terahertz reception electromagnetic waves; and analyzing the plurality of characteristic signals to determine a roughness characteristics of a surface of the test object.

### BACKGROUND OF THE INVENTION

### 1. Field of the Invention

The present invention relates to a surface roughness measurement method and a surface roughness measurement system, and more particularly, to a surface roughness measurement method and a surface roughness measurement system enabling non-contact and non-destructive detection and eliminating the need for reference standard.

### 2. Description of the Prior Art

In modern industrial manufacturing processes, the measurement and control of surface roughness is a critical component in ensuring product quality. Surface roughness not only impacts product appearance but is also intimately connected with numerous crucial characteristics, including mechanical performance, contact characteristics, wear degree, and optical properties. For instance, in precision mechanical machining, the quality of a workpiece's surface roughness directly influences its service life, friction coefficient, and precision; in optical component manufacturing, surface roughness is a key determinant of optical performance.

Traditional surface roughness measurement methods primarily rely on contact-type profilometers, which operate by utilizing a stylus moving along the object's surface. By converting surface height variations into electrical signals through mechanical-to-electrical transduction devices, these instruments obtain surface roughness data. For illustration, reference can be made to FIG. 8 and FIG. 9, which depict a conventional profilometer stylus scanning an object's surface and its scanning results. From FIG. 8, it is evident that when a profilometer stylus scans a surface, there exists a certain discrepancy between the sampling location and the actual surface, resulting in profile curves that do not precisely match the object's surface and consequently contain inherent errors.

Furthermore, the surface roughness determination logic involves assessing height variations of the surface profile relative to a perfectly straight line, necessitating calibration using reference specimens. These reference standards are not only expensive but also require periodic correction to ensure accuracy. Selecting an appropriate reference standard presents a significant challenge, as the standard must possess similar material properties and surface characteristics to the test sample to prevent measurement deviations. Even with reference standard calibration, potential differences between reference and sample signals can introduce system errors, compromising measurement precision. Moreover, the requirement to compare reference standards and test samples under identical conditions imposes stringent environmental (such as temperature and humidity) and instrument state requirements, thereby increasing measurement complexity and cost. More critically, the direct contact of stylus-based measurements can potentially scratch or damage the test sample surface, particularly for low-hardness materials or precision optical components. The mechanical scanning process is time-consuming and cannot be applied in certain specialized scenarios, such as production line real-time inspection or fragile material surface assessment.

Consequently, the industry urgently requires a measurement method that is reference standard-free, non-contact, and capable of rapid and accurate surface roughness measurement. Such a method would enhance measurement efficiency, reduce costs, and expand application scope.

### SUMMARY OF THE INVENTION

Therefore, the present invention is to provide a surface roughness measurement method and a surface roughness measurement system to solve the above issues.

An embodiment of the present invention discloses a surface roughness measurement method, which comprises generating a terahertz emission electromagnetic wave incident on a test object; detecting a plurality of terahertz reception electromagnetic waves reflected, transmitted, or scattered the after terahertz emission electromagnetic wave is incident on the test object; measuring a plurality of characteristic signals based on the terahertz emission electromagnetic wave and the plurality of terahertz reception electromagnetic waves; and analyzing the plurality of characteristic signals to determine a roughness characteristics of a surface of the test object.

Another embodiment of the present invention discloses a surface roughness measurement system, which comprises a terahertz electromagnetic wave generator, configured to generate a terahertz emission electromagnetic wave incident on a test object; a terahertz electromagnetic wave receiver, configured to detect a plurality of terahertz reception electromagnetic waves reflected, transmitted, or scattered after the terahertz emission electromagnetic wave is incident on the test object; and a detection device, coupled to the terahertz electromagnetic wave generator and the terahertz electromagnetic wave receiver, configured to measure a plurality of characteristic signals based on the terahertz emission electromagnetic wave and the plurality of terahertz reception electromagnetic waves, and analyze the plurality of characteristic signals to determine a roughness characteristics of a surface of the test object.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a functional block diagram of a surface roughness measurement system according to an embodiment of the present invention.

FIG. 2 illustrates a schematic diagram of the calculation method for arithmetic mean roughness.

FIG. 3 illustrates a schematic diagram of a surface roughness measurement system according to an embodiment of the present invention.

FIG. 4A and FIG. 4B are schematic diagrams of time-domain and frequency-domain spectra detected by the surface roughness measurement system shown in FIG. 3.

FIG. 5 illustrates a schematic diagram of a surface roughness measurement system according to an embodiment of the present invention.

FIG. 6A and FIG. 6B are schematic diagrams of time-domain and frequency-domain spectra detected by the surface roughness measurement system shown in FIG. 5.

FIG. 7 is a schematic diagram of a test object.

FIG. 8 and FIG. 9 respectively illustrate a conventional profilometer stylus scanning an object surface and scanning results thereof.

FIG. 10 illustrates a schematic diagram of a surface roughness measurement flow according to an embodiment of the present invention.

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

To effectively detect surface roughness, the present invention employs terahertz electromagnetic waves for detection, achieving a method that is reference standard-free, non-contact, and capable of rapid and accurate surface roughness assessment. Terahertz waves operate in the frequency range of 10¹¹ Hz to 10¹³ Hz (0.1 THz to 10 THz), allowing penetration through non-conductive materials and measurement of highly water-containing substances. The advantage of terahertz-based detection lies in the ability to penetrate various materials, enabling assessment of optical coefficients, electrical characteristics, layer thickness, and structural defects within a test object. The terahertz-based detection may be applied in quality control during manufacturing processes, inspection of intermediate or final products, etc. When detecting the test object using terahertz electromagnetic waves, the frequency of terahertz waves is much lower than that of infrared electromagnetic waves (ranging from 10¹³ Hz to 10¹⁵ Hz), such that the energy carried by terahertz photons is smaller, to prevent disruption in molecular structures, and thus maintain the integrity of structures without causing further damage or expanding existing defects, to dramatically reduce the probability of destructive product testing.

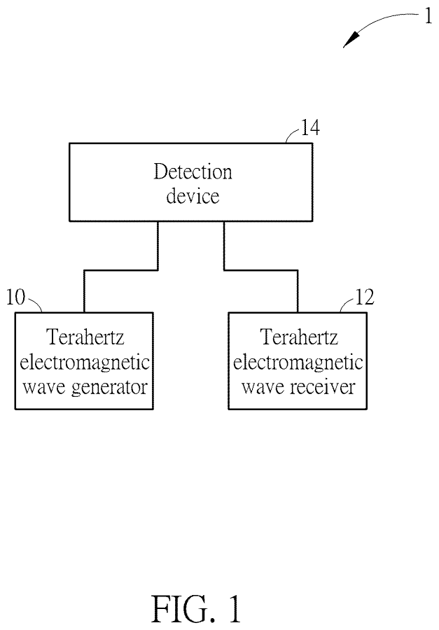

Specifically, please refer to FIG. 1, which illustrates a functional block diagram of a surface roughness measurement system 1 according to an embodiment of the present invention. The surface roughness measurement system 1 comprises a terahertz electromagnetic wave generator 10, a terahertz electromagnetic wave receiver 12, and a detection device 14, which can detect surface roughness of a test object, or more specifically, to non-contactively determine a roughness characteristics of a surface of the test object. The test object may be selected from one or more of a semiconductor wafer, a ceramic material, a polymer material, a metal material, and a composite material, and not limited thereto. The terahertz electromagnetic wave generator 10 is configured to generate a terahertz emission electromagnetic wave incident at various angles on the test object. The terahertz electromagnetic wave receiver 12 is configured to detect a plurality of terahertz reception electromagnetic waves reflected, transmitted, or scattered after the terahertz emission electromagnetic wave is incident on and passes through the test object. The detection device 14 is coupled to the terahertz electromagnetic wave generator 10 and the terahertz electromagnetic wave receiver 12, and configured to measure a plurality of characteristic signals based on the terahertz emission electromagnetic wave and the plurality of terahertz reception electromagnetic waves, and analyze the plurality of characteristic signals to determine a roughness characteristics of the surface of the test object. Thus, the surface roughness measurement system 1 achieves non-contact roughness measurement, preserves the integrity of the surface of the test object and eliminates the need for reference standard calibration.

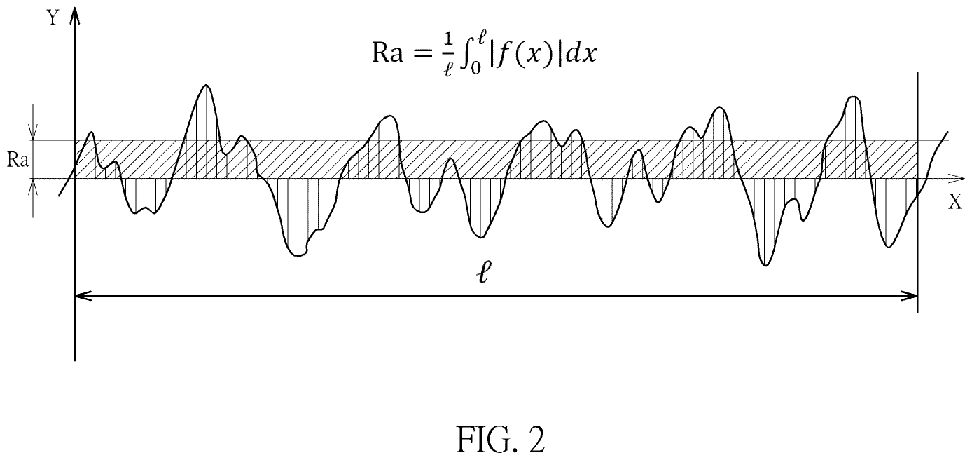

Surface roughness typically refers to the microscopic geometric shape features composed of peaks and valleys on an object's surface, representing a microscopic geometric shape error. According to surface roughness standards defined by International Organization for Standardization (e.g. ISO 1302), common representation methods for surface roughness include arithmetic mean surface roughness (Ra), ten-point average roughness (Rz), and maximum height (Ry or Rmax). For example, the arithmetic mean roughness (Ra) is the most commonly used parameter for measuring surface roughness, and represents the average absolute deviation from a baseline within a sampling length. A smaller Ra value indicates a smoother surface with minimal height variations, while a larger Ra value suggests a rougher surface with more significant height differences. The calculation method for the Ra value can be referenced in FIG. 2. The fundamental concept involves sampling a baseline length l on the object's surface, establishing the baseline direction as the X-axis and the vertical magnification direction as the Y-axis. The Ra value is determined using the following equation:

$$Ra = \frac{1}{ℓ} {\int }_{0}^{ℓ} \vert f ( x ) \vert dx ; \qquad ( Eq . 1 )$$

where f(x) represents roughness curve or profile curve.

Eq. 1 represents an integral calculation, which can alternatively be expressed in a discrete form, specifically:

$$Ra = ( 1 / n ) * \sum \vert yi \vert \qquad ( Eq . 2 )$$

where n represents the total number of measurement points, and yi represents the distance from the baseline for the i-th measurement point on the profile curve.

The ten-point average roughness (Rz) represents the average of the absolute values of the heights of the five highest peaks and the five lowest valleys on the measured profile curve within a sampling length. The Rz value reflects the height of the larger peaks and valleys on the surface. Compared to the Ra value, the Rz value more accurately reflects the larger irregularities on the surface, especially isolated peaks and valleys. The maximum height refers to the vertical distance between the highest and lowest points on the profile curve within the sampling length, providing an understanding of the maximum height difference of the surface.

It should be noted that arithmetic average roughness, ten-point average roughness, and maximum height are all indicators used to represent surface roughness, and their calculation methods are well-known to those skilled in the art, so they will not be elaborated here. In addition, any parameter that can be used to measure surface roughness can be detected using the detection device 14, without being limited to these parameters. In other words, depending on the roughness indicator to be used, the detection device 14 can utilize terahertz emission and reception electromagnetic waves to determine the characteristic signals of the test object, determine at least a profile curve of at least one position on the surface of the test object, and accordingly calculate at least one roughness at the at least one position based on the profile curve, so as to assess the roughness characteristics of the surface.

In one embodiment, if the roughness indicator used is the arithmetic average roughness, the detection device 14 can calculate the profile curve of at least one position (e.g., three positions) on the test object, and determine an average of the absolute values of the deviations from the baseline at these positions over a reference length. The reference length can be, but is not limited to, 4 millimeters. In another embodiment, if the roughness indicator used is the ten-point average roughness, the detection device 14 can calculate the five highest peaks and the five lowest valleys on the profile curve within the sampling length at at least one position of the test object, then calculate the average of the absolute values of the heights of these peaks and valleys. In yet another embodiment, if the roughness indicator used is the maximum height, the detection device 14 can calculate the vertical distance between the highest and lowest points on the profile curve within the sampling length at at least one position of the test object.

In short, the detection device 14 can determine the characteristic signals of the test object based on the terahertz emission and reception of electromagnetic waves related to the test object, and accordingly analyze the vertical undulation state of the surface of the test object. This provides information related to the profile curve, which in turn allows for determining the surface roughness and its characteristics.

It is important to note that the detection device 14 determines the vertical undulation state of the surface of the test object based on terahertz emission and reception electromagnetic waves, and the implementation is not limited to specific methods. For example, the applicant of the present application has provided a composite structure detecting method and system capable of detecting a composite structure with multiple interface layers in U.S. patent application Ser. No. 18/813,045. In this context, the surface of the test object can be viewed as the interface between the test object body and the air, with the test object body and the air representing two interface layers, and their intersection defining the surface of the test object. Specifically, the detection device 14 can measure characteristic signals based on the terahertz emission and reception electromagnetic waves, to obtain information such as signal phase differences and signal intensity variations, thereby analyzing the surface structure or height changes of the test object to determine the profile curve of the surface of the test object. Therefore, through the composite structure detecting method and system of Ser. No. 18/813,045, the detection device 14 of the embodiment of the present invention can distinguish the surface of the test object, thereby determining the vertical undulation state of the surface of the test object and obtaining information related to the profile curve. Furthermore, the applicant in U.S. patent application Ser. No. 18/885,738 has provided a layered detection method and system, which is based on Fresnel equations to stratify solid materials and determine the characteristics of each layer, thereby judging the defect information of each layer. Through the detection method and system of Ser. No. 18/885,738, the detection device 14 of the embodiment of the present invention can view the surface of the test object as the interface between the air and the test object body, and further determine the undulation state of the surface based on the electromagnetic field intensity variations at the medium interface, thus determining the profile curve of the test object surface. In addition, based on the methods and systems of patent application Ser. Nos. 18/813,045 and 18/885,738, the detection device 14 of the embodiment of the present invention can also analyze the coefficients of the test object, such as refractive index, dielectric constant, conductivity, dopant concentration, and can analyze the internal layer structures of the test object and whether there are defects or provide grounds for identifying defects, where such defects may include material inhomogeneity (such as bubbles, uneven mixing of materials), lattice dislocations, uneven dopant concentration. Specifically, the detection device 14 can measure the transient electrical field of each terahertz reception electromagnetic wave in the time domain to obtain the field strength, field phase, and field frequency of the transient (time-domain) electrical field, and through transformation (such as Fourier transform) obtain the spectral electrical field between terahertz reception electromagnetic waves to obtain the field amplitude, field polarization, and field phase of the spectral electrical field. In other words, the characteristic signals measured by the detection device 14 can include the transient field strength and phase of each terahertz reception electromagnetic wave (in the time domain) and the spectral electrical field amplitude, polarization, and phase between terahertz reception electromagnetic waves (in the frequency domain). Since the characteristic signals (transient field strength and phase, spectral electrical field amplitude, polarization, and phase) are highly sensitive to material properties, the detection device 14 can directly measure material optical coefficients (such as absorption rate, refractive index, reflectivity, or transmittance), electrical coefficients (such as conductivity, resistivity, dopant concentration, dielectric coefficient, and charge carrier mobility), and structural characteristics through physical formula calculations. On the other hand, the detection device 14 can measure the time of flight of multiple terahertz reception electromagnetic waves and analyze the time of flight to determine the internal thickness of the test object. Thus, the detection device 14 can analyze whether the structure of the test object has abnormalities, whether component positions are unusual, whether thickness matches design specifications, stress variations, and can serve as a basis for determining whether process technology is incorrect or whether components are defective, based on the time-domain flight time spectral signal.

Therefore, by comparing terahertz emission electromagnetic waves and terahertz reception electromagnetic waves, the detection device 14 can measure multiple characteristic signals related to the test object, thereby determining the characteristics of the test object, particularly its roughness characteristics. The characteristic signals can include the strength and phase of the time-domain electrical field of each terahertz reception electromagnetic wave and/or the amplitude and phase of the spectral electrical field between terahertz reception electromagnetic waves. The characteristics of the test object can include at least one of thickness, optical coefficients, electrical coefficients, structural state, resistance, and stress variations. The electrical coefficients can include at least one of conductivity, resistivity, dopant concentration, dielectric coefficient, and charge carrier mobility, while optical coefficients can include at least one of absorption rate, refractive index, reflectivity, and transmittance. Accordingly, the detection device 14 can further determine whether the test object contains defects or provide grounds for identifying defects.

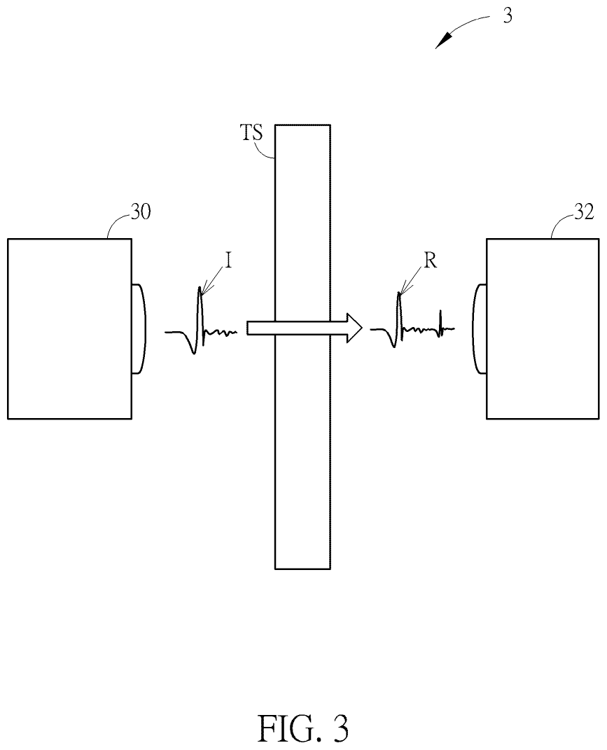

It should be noted that the method of the detection device 14 for determining the vertical undulation state of the test object surface in the embodiment of the present invention is not limited to the methods and systems of U.S. patent application Ser. Nos. 18/813,045 and 18/885,738, but can be various methods or systems using electromagnetic wave detection. Moreover, the surface roughness measurement system 1 in FIG. 1 represents the essential functional components of the embodiment of the present invention, but when implementing the surface roughness measurement system 1, those skilled in the art can design or select appropriate architectures based on actual needs. For example, please refer to FIG. 3, which illustrates a schematic diagram of a surface roughness measurement system 3 according to an embodiment of the present invention. The surface roughness measurement system 3 is derived from the surface roughness measurement system 1, and employs a transmission-type terahertz electromagnetic wave detection architecture. For brevity, FIG. 3 omits the related position of the detection device 14, which can be understood by those skilled in the art based on FIG. 1. In detail, the surface roughness measurement system 3 generates a terahertz emission electromagnetic wave I through a terahertz electromagnetic wave generator 30, irradiates it onto a test object TS, and uses a terahertz electromagnetic wave receiver 32 to detect multiple terahertz reception electromagnetic waves R transmitted after the terahertz emission electromagnetic wave I is incident on the test object TS.

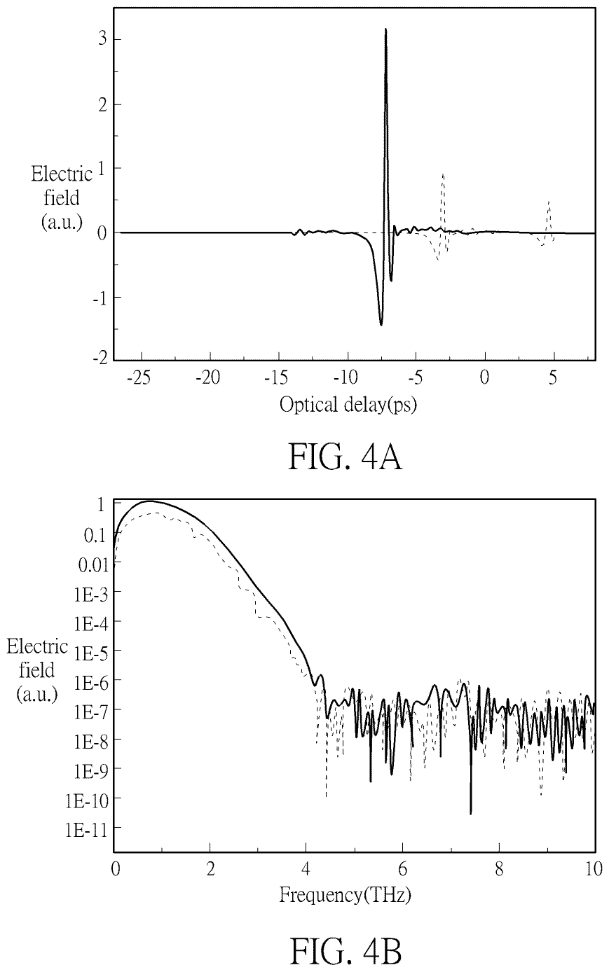

The surface roughness measurement system 3 uses a transmission-type terahertz electromagnetic wave detection architecture, which can compare signals from detecting air with signals from detecting the test object TS, analyzing time-domain and frequency-domain spectra to measure characteristic signals. For example, please refer to FIG. 4A and FIG. 4B, which are schematic diagrams of time-domain and frequency-domain spectra detected by the surface roughness measurement system 3. In FIG. 4A, the solid line represents the electric field versus the optical delay (time-domain spectrum) when the terahertz emission electromagnetic wave detects air (without a test object), while the dashed line represents the electric field versus the optical delay result (time-domain spectrum) when the terahertz emission electromagnetic wave detects a test object. In FIG. 4B, the solid line represents the electric field versus the frequency (frequency-domain spectrum) when the terahertz emission electromagnetic wave detects air (without a test object), while the dashed line represents the electric field versus the frequency when the terahertz emission electromagnetic wave detects a test object. Therefore, by analyzing the time-domain and frequency-domain spectra, the detection device 14 in the transmission-type detection architecture can measure characteristic signals to obtain information such as signal phase differences and signal intensity variations. This allows for analyzing the surface structure or height changes of the test object to determine its surface profile curve. The detection device 14 can also analyze coefficients such as the refractive index, dielectric constant, conductivity, and dopant concentration of the test object and air, and can analyze the internal structure of the test object and whether there are defects or provide grounds for identifying defects. Such defects may include material inhomogeneity (such as bubbles, uneven mixing of materials), lattice dislocations, and uneven dopant concentration.

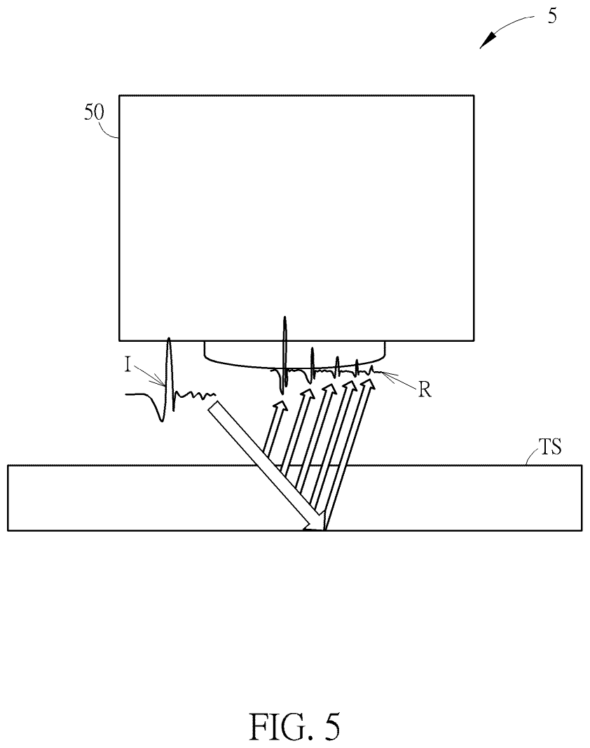

On the other hand, please refer to FIG. 5, which is a schematic diagram of a surface roughness measurement system 5 according to an embodiment of the present invention. The surface roughness measurement system 5 is derived from the surface roughness measurement system 1, utilizing a reflective terahertz electromagnetic wave detection architecture. For brevity, FIG. 5 omits the related position of the detection device 14, which can be understood by those skilled in the art based on FIG. 1. Specifically, the surface roughness measurement system 5 employs a reflective detection architecture where the terahertz electromagnetic wave generator and receiver 50 simultaneously integrates the functions of terahertz electromagnetic wave emission and reception. In other words, the terahertz electromagnetic wave generator and receiver 50 can generate terahertz emission electromagnetic wave I, irradiate it onto the test object TS, and detect multiple terahertz reception electromagnetic waves R reflected after the terahertz emission electromagnetic wave I is incident on the test object. Additionally, the operation of surface roughness measurement system 5 can be referenced from the previously described operations of the surface roughness measurement systems 1 and 3.

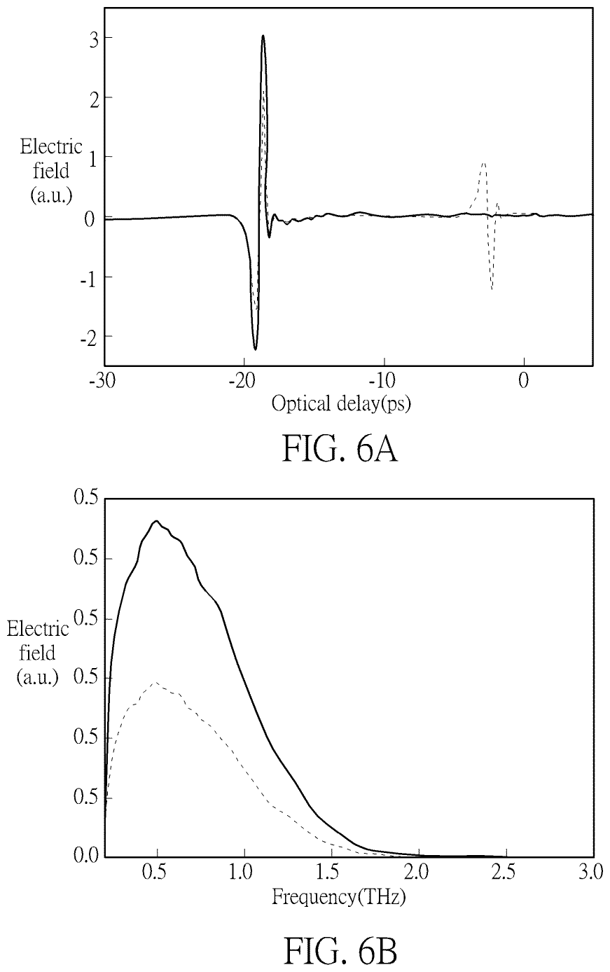

Further, please refer to FIG. 6A and FIG. 6B, which are time-domain and frequency-domain spectral diagrams for the detection of the surface roughness measurement system 5. In FIG. 6A, the solid line represents the electric field versus the optical delay (time-domain spectrum) when the terahertz emission electromagnetic wave detects a metal plate or high-conductivity material, while the dashed line represents the electric field versus the optical delay (time-domain spectrum) when the terahertz emission electromagnetic wave detects the test object. In FIG. 6B, the solid line represents the electric field versus the frequency (frequency-domain spectrum) when the terahertz emission electromagnetic wave detects a metal plate or high-conductivity material, while the dashed line represents the electric field versus the frequency (frequency-domain spectrum) when the terahertz emission electromagnetic wave detects the test object. By analyzing the time-domain and frequency-domain spectra, the detection device 14 in the reflective detection architecture can measure characteristic signals, obtaining information such as signal phase differences and signal intensity variations. This allows for analyzing the surface structure or height changes of the test object to determine its profile curve. The detection device 14 can also analyze parameters like refractive index, dielectric constant, conductivity, and dopant concentration, and can examine the internal structure of the test object or provide grounds for identifying defects. Such defects may material inhomogeneity (such as bubbles or uneven material mixing), lattice dislocations, and uneven dopant concentration.

It is important to note that the surface roughness measurement systems 3 and 5 are transmission and reflection-based terahertz electromagnetic wave detection architectures derived from the surface roughness measurement system 1. Those skilled in the art should choose an appropriate architecture based on actual needs or items to be detected, and are not limited to these configurations. Generally, transmission-based terahertz electromagnetic wave detection architectures can directly penetrate the test object, obtaining overall signal phase difference and signal intensity variation information. In contrast, reflection-based terahertz electromagnetic wave detection architectures reflect a signal when passing through the surface of the test object, returning one or multiple terahertz waves. By analyzing the phase differences and signal intensity variations of these signals, the detection device 14 can determine the surface structure, height variations, and material parameters such as refractive index, dielectric constant, conductivity, dopant concentration, and stress.

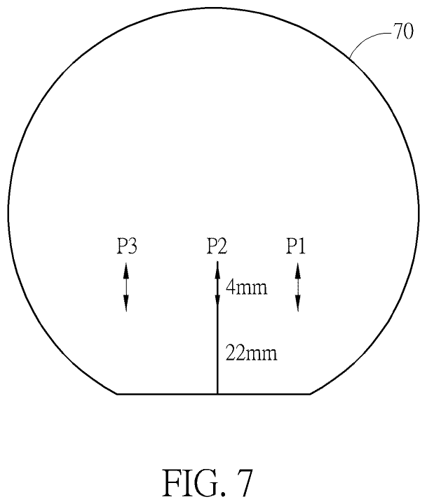

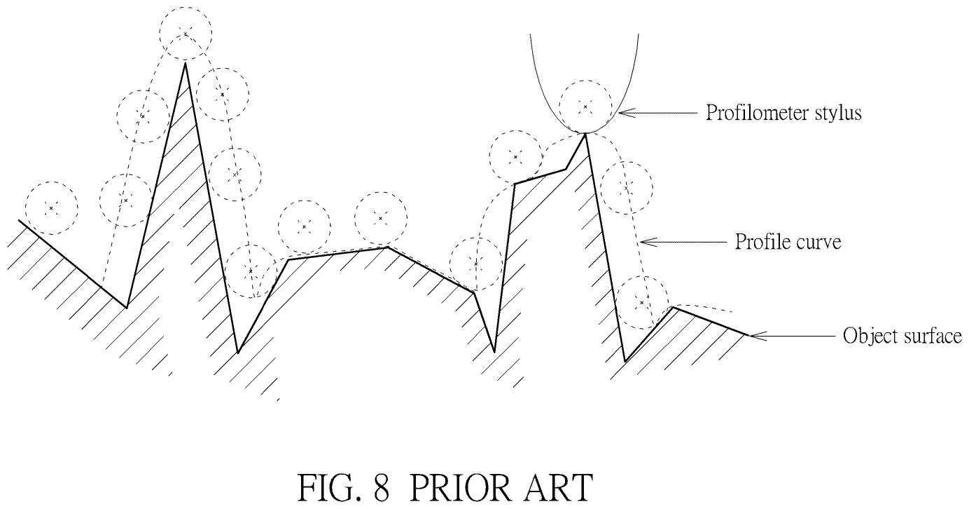

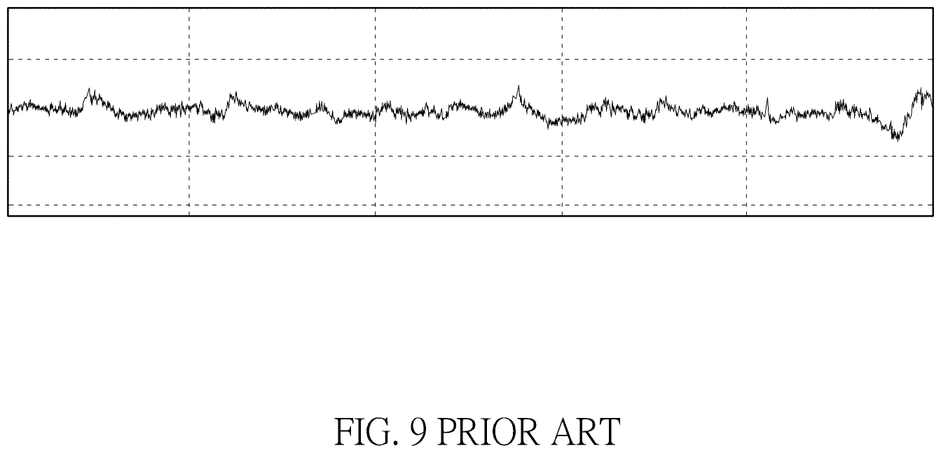

FIG. 4A, FIG. 4B, FIG. 6A, and FIG. 6B illustrate the single-point detection results of the surface roughness measurement systems 3 and 5 using terahertz electromagnetic waves. From these results, the detection device 14 can further analyze the coefficients of the test object, such as refractive index, dielectric constant, conductivity, and dopant concentration, and can analyze the internal structure of the test object and whether there are defects or provide grounds for identifying defects. When conducting surface roughness testing, those skilled in the art can scan a specific baseline length by moving the detector or sample platform to determine the profile curve within the baseline length. For example, please refer to FIG. 7, which is a schematic diagram of a test object 70. When the surface roughness measurement systems 1, 3, and 5 detect the surface roughness of the test object 70, three test positions P1, P2, and P3 can be selected on the test object 70, with sampling performed at each test position. The sampling baseline length is 4 millimeters (mm), with one end of the test points located 22 mm from the bottom flat edge of the test object 70. Each test position can be tested three times, with the average taken. In this way, corresponding profile curves can be obtained at the test positions P1, P2, and P3, which can be used to further calculate surface roughness, such as arithmetic mean roughness, ten-point average roughness, maximum height, etc., thereby determining the roughness characteristics of the test object 70.

Therefore, by sampling the test object with terahertz electromagnetic waves over a specific length, the surface roughness measurement systems 1, 3, and 5 can directly obtain the surface profile curve and subsequently calculate roughness parameters.

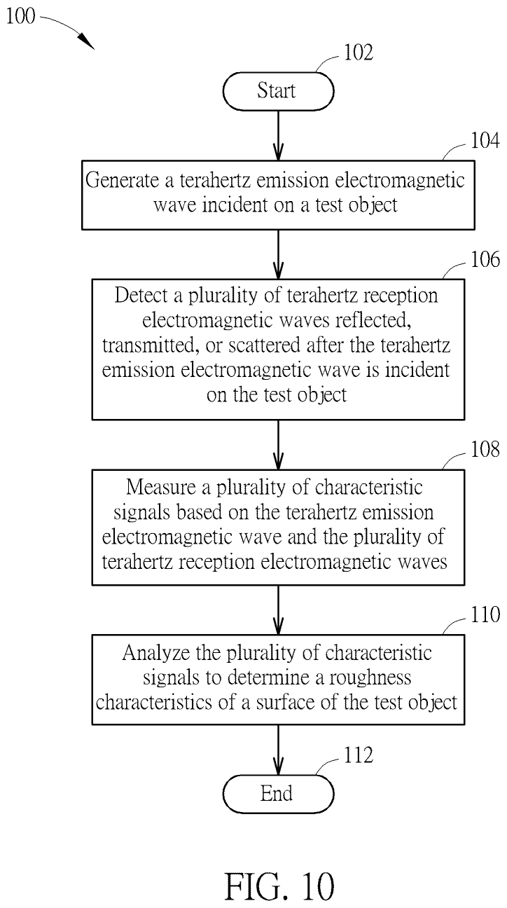

The operational methods of the surface roughness measurement systems 1, 3, and 5 can be summarized in a surface roughness measurement flow 100, as shown in FIG. 10. The surface roughness measurement flow 100 is utilized for detecting a test object and comprises:

Step 102: Start.

Step 104: Generate a terahertz emission electromagnetic wave incident on a test object.

Step 106: Detect a plurality of terahertz reception electromagnetic waves reflected, transmitted, or scattered after the terahertz emission electromagnetic wave is incident on the test object.

Step 108: Measure a plurality of characteristic signals based on the terahertz emission electromagnetic wave and the plurality of terahertz reception electromagnetic waves.

Step 110: Analyze the plurality of characteristic signals to determine a roughness characteristics of a surface of the test object.

Step 112: End.

Detailed operation and variations of the surface roughness measurement flow 100 can be referenced from the previous explanation and are not repeated here.

In the prior art, surface roughness measurement primarily uses contact-type profilometers, which require direct contact between the stylus and the surface of the test object and necessitate using a reference specimen as a standard. This measurement method not only potentially damages the surface of the test object but also limits resolution due to stylus size constraints. The selection and calibration of reference specimens add complexity and uncertainty to the measurement. Moreover, the prior art methods face numerous limitations when measuring special materials like fragile, deformable, or specially surface-treated materials. In contrast, the present invention measures multiple characteristic signals based on terahertz emission and reception electromagnetic waves and analyzes these signals to determine the roughness characteristics of the surface of the test object. The terahertz waves' non-contact, non-destructive nature ensures no damage to the surface of the test object. Importantly, the present invention eliminates the need for reference specimens, directly obtaining surface profile curves by analyzing the interaction between terahertz waves and the surface of the test object. Consequently, the present invention is applicable to various test objects and can be used for real-time production line inspections and process quality control. By conducting repeated measurements at multiple test positions and taking averages, the reliability and reproducibility of measurements can be ensured. Additionally, the non-contact measurement method is particularly suitable for surface-sensitive precision components' roughness measurement. Thus, the present invention not only overcomes the limitations of the prior art measurement methods but also provides a more convenient, accurate, and broadly applicable surface roughness measurement solution.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A surface roughness measurement method, comprising:
generating a terahertz emission electromagnetic wave incident on a test object;
detecting a plurality of terahertz reception electromagnetic waves reflected, transmitted, or scattered after the terahertz emission electromagnetic wave is incident on the test object;
measuring a plurality of characteristic signals based on the terahertz emission electromagnetic wave and the plurality of terahertz reception electromagnetic waves; and
analyzing the plurality of characteristic signals to determine a roughness characteristics of a surface of the test object.

2. The surface roughness measurement method of claim 1, wherein the step of analyzing the plurality of characteristic signals to determine the roughness characteristics of the surface of the test object comprises:
determining at least one profile curve of at least one position of the surface based on the plurality of characteristic signals; and
calculating at least one roughness of the at least one position of the surface based on the at least one profile curve to determine the roughness characteristics of the surface.

3. The surface roughness measurement method of claim 2, wherein the at least one roughness is selected from one or more of an arithmetic mean roughness, a ten-point average roughness, and a maximum height roughness.

4. The surface roughness measurement method of claim 1, wherein a frequency of the terahertz emission electromagnetic waves is between 1011 Hz and 1013 Hz.

5. The surface roughness measurement method of claim 1, wherein the plurality of characteristic signals comprise an electric field polarization, an electric field intensity and an electric field phase of each of the plurality of terahertz reception electromagnetic waves.

6. The surface roughness measurement method of claim 5, wherein the plurality of characteristic signals further comprise at least one spectral electric field between the plurality of terahertz reception electromagnetic waves, and each spectral electric field comprises an electric field amplitude and an electric field phase.

7. The surface roughness measurement method of claim 1, wherein the test object is selected from one or more of a semiconductor wafer, a ceramic material, a polymer material, a metal material, and a composite material.

8. A surface roughness measurement system, comprising:
a terahertz electromagnetic wave generator, configured to generate a terahertz emission electromagnetic wave incident on a test object;
a terahertz electromagnetic wave receiver, configured to detect a plurality of terahertz reception electromagnetic waves reflected, transmitted, or scattered after the terahertz emission electromagnetic wave is incident on the test object; and
a detection device, coupled to the terahertz electromagnetic wave generator and the terahertz electromagnetic wave receiver, configured to measure a plurality of characteristic signals based on the terahertz emission electromagnetic wave and the plurality of terahertz reception electromagnetic waves, and analyze the plurality of characteristic signals to determine a roughness characteristics of a surface of the test object.

9. The surface roughness measurement system of claim 8, wherein the detection device is configured to determine at least one profile curve of at least one position of the surface based on the plurality of characteristic signals, and calculate at least one roughness of the at least one position of the surface based on the at least one profile curve to determine the roughness characteristics of the surface.

10. The surface roughness measurement system of claim 9, wherein the at least one roughness is selected from one or more of an arithmetic mean roughness, a ten-point average roughness, and a maximum height roughness.

11. The surface roughness measurement system of claim 8, wherein a frequency of the terahertz emission electromagnetic waves is between 1011 Hz and 1013 Hz.

12. The surface roughness measurement system of claim 8, wherein the plurality of characteristic signals comprise an electric field polarization, an electric field intensity and an electric field phase of each of the plurality of terahertz reception electromagnetic waves.

13. The surface roughness measurement system of claim 12, wherein the plurality of characteristic signals further comprise at least one spectral electric field between the plurality of terahertz reception electromagnetic waves, and each spectral electric field comprises an electric field amplitude and an electric field phase.

14. The surface roughness measurement system of claim 8, wherein the test object is selected from one or more of a semiconductor wafer, a ceramic material, a polymer material, a metal material, and a composite material.
